(19) United States
(12) Patent Application Publication
(10) Pub. No.: US 2011/0102865 A1
(43) Pub. Date: May 5, 2011

(54) IMAGE READING APPARATUS

(75) Inventors: Takeshi Ishida, Toyohashi-shi (JP); Toshikazu Higashi, Toyokawa-shi (JP); Takashi Watanabe, Toyokawa-shi (JP); Masahiro Nonoyama, Toyokawa-shi (JP)

(73) Assignee: Konica Minolta Business Technologies, Inc., Tokyo (JP)

(21) Appl. No.: 13/000,973

(22) PCT Filed: Jul. 30, 2009
(86) PCT No.: PCT/JP2009/063557

§ 371 Date: Dec. 22, 2010

(30) Foreign Application Priority Data
Sep. 10, 2008 (JP) 2008-232660

(51) Int. Cl. H04N 1/04

(52) U.S. Cl. 358/498

(57) ABSTRACT

An object of the present invention is to provide an image reading apparatus that has a simple mechanism for ejecting dust collected from a transparent member by a cleaner to the outside, thereby preventing stripe noise from being mixed into read image data.

Disclosed is an image reading apparatus, wherein while an automatic document feeder is feeding a document (D) such that the document (D) passes over a reading glass (40), an image of the document is optically read at a reading position (A). Above the reading glass (40), a brush type cleaner (45) is disposed to face to the reading position (A) and to be capable of rotating. At a downstream position from the cleaner (45) with respect to a document feeding direction (B), a duster (46) is disposed for a dusting operation to remove dust from the cleaner by slapping against the cleaner (45). Before the leading edge of the document (D) comes to the reading position (A), the cleaner (45) rotates to clean the reading glass (40), and while the document (D) is covering the reading glass (40), the duster (46) slaps against the cleaner (45) to dust the cleaner (45).

### REFERENCE TO RELATED APPLICATIONS

This application is a national stage application under 35 USC 371 of International Application No. PCT/JP2009/063557, filed Jul. 30, 2009, which claims the priority of Japanese Application No. 2008-232660, filed Sep. 10, 2008, the contents of which prior applications are incorporated herein by reference.

### FIELD OF THE INVENTION

The present invention relates to an image reading apparatus, and more particularly to a sheet-through type image reading apparatus that is used as an image data input device for a copying machine, a scanner or the like.

### BACKGROUND OF THE INVENTION

An image reading apparatus for reading a document image optically is conventionally of a platen-set type that reads an image of a document set on a platen glass or of a sheet-through type that reads an image of a document while the document is being fed, or alternatively is operable both as a platen-set type and as a sheet-through type. The sheet-through type has advantages of small size, low cost, low noise, high-speed reading and high printing efficiency. Therefore, in most monochromatic and color copying machines, image reading apparatuses of the sheet-through type are used.

In an image reading apparatus of the sheet-through type, the image reading position is fixed and specifically fixed on a transparent member (a narrow and long reading glass), and a reading optical system focuses on an imaged surface of a fed document via the reading glass. In this structure, the image reading is apt to be influenced by dust and other particles stuck on the reading glass, and in the portions where light is shielded by the particles, stripe noise is mixed into read image data. When the documents are paper, it inevitably occurs that small particles of filler, such as calcium carbonate, and pulp contained in paper adhere to the reading glass.

As measures to avoid the trouble, an image reading apparatus of the sheet-through type conventionally performs the following control while processing a read image; alarming the user when detecting dust particles on the image; erasing stripe noise as a step of image processing; or moving the reading glass so as not to read the dust particles repeatedly. However, these measures are not to prevent deposition of dust particles on the reading glass, and finally, the reading glass must be cleaned by a serviceman.

Also, patent documents 1 and 2 suggest image reading apparatuses that have a mechanism for cleaning the reading glass. With merely the mechanism for cleaning the reading glass, it may happen that dust particles caught in a cleaner adhere to the reading glass again. In order to prevent adherence of dust particles back to the reading glass, it is necessary to provide a dust collector, which results in complication of the apparatus.
Patent Document 1: Japanese Patent Laid-Open Publication No. 6-164863
Patent Document 2: Japanese Patent Laid-Open Publication No. 2000-270152

### SUMMARY OF THE INVENTION

An object of the present invention is to provide an image reading apparatus that has a simple mechanism for ejecting dust collected from a transparent member by a cleaner to the outside, thereby preventing stripe noise from being mixed into read image data.

In order to attain the object, an image reading apparatus according to an embodiment of the present invention comprises:
an automatic document feeder for feeding documents one by one such that each document can pass through a reading position;
an image reader for optically reading an image of a document while the document is passing the reading position;
a transparent member that is disposed between the document passing the reading position and the image reader;
a brush type cleaner that is disposed to face to the transparent member at the reading position and that is capable of rotating to perform a cleaning operation to clean the transparent member;
a duster that is disposed at a downstream position from the cleaner with respect to a document feeding direction and that is capable of slapping against the cleaner to perform a dusting operation to remove dust from the cleaner; and
a controller that controls rotation of the cleaner,
wherein the controller controls the cleaning operation to be carried out by rotating the cleaner before a leading edge of a document comes to the reading position and control the dusting operation by the duster to be carried out while the document is covering the transparent member.

In the image reading apparatus, before the leading edge of the document comes to the reading position, the brush type cleaner rotates to collect dust from the transparent member. Thereafter, while the document is covering the transparent member, the duster slaps against the cleaner to remove the dust from the cleaner. The dust falls on the reverse side of the document that is traveling on the reading position, and the dust is carried by the document and ejected from the image reading apparatus to the outside.

Dust that fell from a document onto the transparent member is cleaned and collected by the cleaner before a next document comes to the reading position, and the dust is dropped from the cleaner onto the reverse side of the next document. Thereby, the dust is carried by the next document and ejected from the image reading apparatus to the outside. In this way, the cleaner can be kept clean at all times, and there is no fear that dust collected by the cleaner may stick to the transparent member again, thereby preventing stripe noise from being mixed into read image data. Further, it is not necessary to provide a separate dust collector, which never causes complication of the apparatus.

According to the present invention, dust collected from a transparent member by a cleaner can be ejected to the outside in a simple structure, and stripe noise can be prevented from being mixed into read image data.

### BRIEF DESCRIPTION OF THE DRAWINGS

FIG. 1 is a schematic view of an image reading apparatus according to an embodiment of the present invention.

FIG. 2 is an illustration showing a cleaning operation carried out by a cleaner.

FIG. 3 is an illustration showing a dusting operation to dust the cleaner.

FIG. 4 is a block diagram showing a control section of the image reading apparatus.

FIG. 5 is a timing chart showing a basic control sequence of a document feeding operation, the cleaning operation and the dusting operation.

FIG. 6 is a timing chart showing a control sequence when the document is fed at a high speed.

FIG. 7 is a timing chart showing a control sequence when the document is fed at a low speed.

FIG. 8 is a flowchart showing a first exemplary control procedure.

FIG. 9 is a timing chart showing a control sequence when the dusting operation includes plural slaps.

FIG. 10 is an illustration showing the time to start the dusting operation and the time to complete the dusting operation.

FIG. 11 is a flowchart showing a second exemplary control procedure.

### DETAILED DESCRIPTION OF THE INVENTION

Referring to the drawings, an image reading apparatus according to an embodiment of the present invention is described. In the drawings, the same parts and members are provided with the same reference symbols, and repetitions of descriptions thereof are omitted.

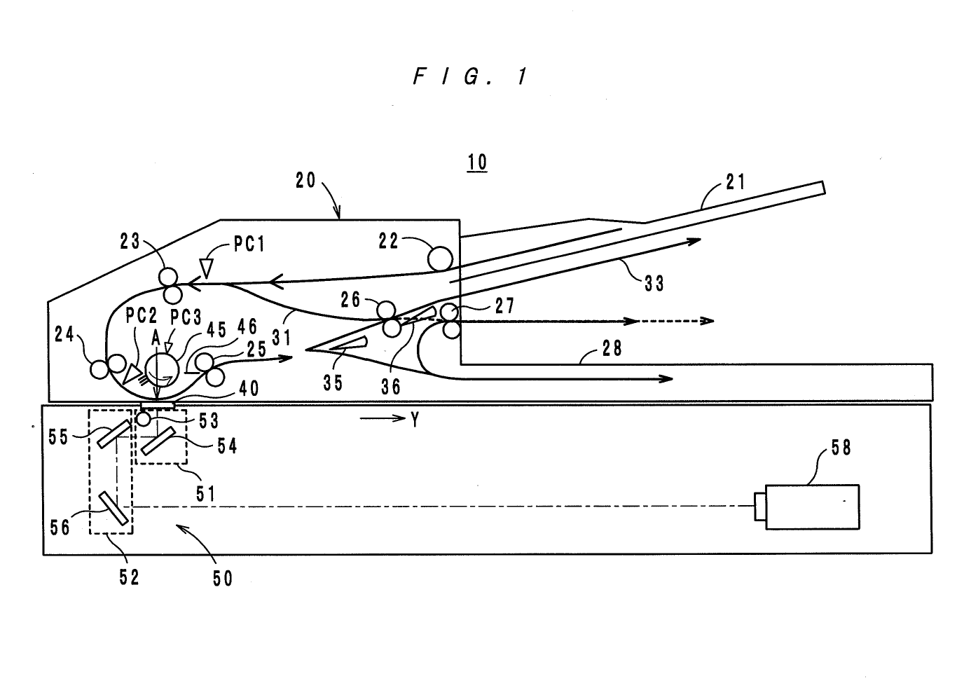

As shown in FIG. 1, an image reading apparatus 10 according to an embodiment of the present invention is operable both in a platen-set method wherein an image of a document set on a platen glass is read and in a sheet-through method wherein an image of a document fed by an automatic document feeder 20 is read. The image reading apparatus 10 has an image reading optical system (scanner) 50.

The image reading optical system 50 is of a conventional type that comprises a lamp 53, mirrors 54, 55 and 56, an imaging lens (not shown) and an image pick-up section (a CCD color line sensor) 58. In order to permit image reading in the platen-set method, the lamp 53 and the mirror 54 are mounted on a first slider 51, and the mirrors 55 and 56 are mounted on a second slider 52, the first slider 51 and the second slider 52 being movable in a sub-scanning direction “Y”. Image reading in the sheet-through method is performed with the optical system 50 stationary in a reading position A as shown in FIG. 1.

The automatic document feeder 20 comprises a document tray 21, a feed roller 22, a pair of resist rollers 23, a reading section comprising pairs of reading rollers 24 and 25, a document ejection section comprising pairs of ejection rollers 26 and 27, and an ejected-document tray 28. Further, a transparent member (which will be hereinafter referred to as a reading glass 40) is provided at the reading position A.

The document ejection section functions to eject a document that has passed through the reading position A to the tray 28. The document ejection section further comprises diverters 35 and 36 so that the document can be fed back onto the reading glass 40 via a cyclic sheet path 31 for reading of an image on the reverse side of the document and thereafter ejected onto the tray 28.

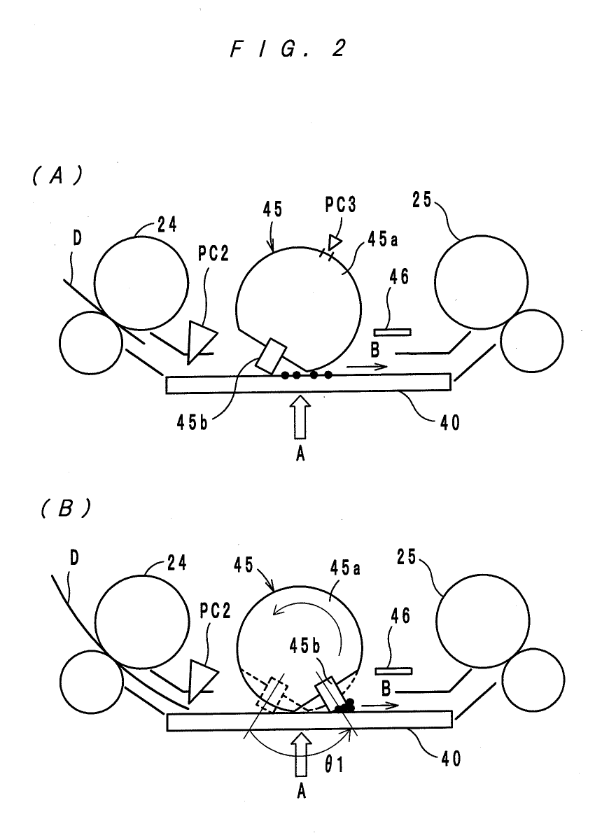

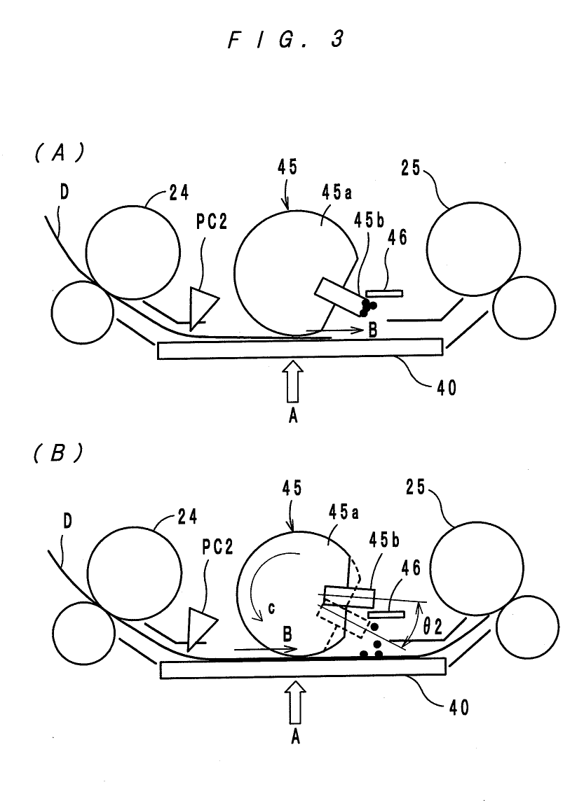

A brush type cleaner 45 is disposed to face to the reading position A of the reading glass 40, and the cleaner 45 is capable of rotating. Further, a duster 46 is disposed in a position downstream from the cleaner 45 in a document feeding direction B (see FIG. 3). As shown in FIG. 2, the cleaner 45 has a cleaning brush 45b fixed on a flat surface of a shaft 45a and extending in a direction perpendicular to the document feeding direction B. The cleaner 45 can be driven to make reciprocating rotations. The cleaning brush 45b is, for example, a bundle of conductive polyimide resin fibers of about two deniers.

The duster 46 is fixed at a position, and while the brush 45b rotates in a direction or makes a reciprocating rotation within a specified angle θ2 as shown by FIG. 3(B), the duster 46 removes dust from the cleaning brush 45b.

The automatic document feeder 20 further comprises a pre-resist sensor PC1 and a pre-reading sensor PC2 each for detecting a document, and a home position sensor PC3 for detecting the cleaner 45 in a home position (see FIG. 2(A)).

A cleaning operation is described below. As shown by FIGS. 2(A) and (B), before the leading edge of a document D comes to the reading position A, the cleaner 45 rotates to clean the reading glass 40 and collect dust. The angle of rotation θ1 of the cleaner 45 corresponds to a cleaning area. Thereafter, as shown by FIGS. 3(A) and (B), while the document D is traveling on the reading glass 40, the cleaner 45 makes a reciprocating rotation within the angle θ2. Thereby, the cleaning brush 45b slaps against the duster 46, and the duster 46 removes dust from the cleaning brush 45b. The dust removed from the brush 45b falls on the reverse side of the document D that is traveling on the reading glass 40, and the dust is carried by the document D to the outside of the image reading apparatus 10.

Thus, dust that fell from a document onto the reading glass 40 is collected by the cleaner 45 before a next document D comes to the reading position A, and the dust collected in the cleaner 45 is removed therefrom onto the reverse side of the document D. Then, the dust is carried by the document D and is ejected from the apparatus 10. In this way, the cleaning brush 45b is kept clean at all times, and there is no fear that dust collected from the reading glass 40 into the cleaning brush 45b may stick to the reading glass 40 again. Therefore, stripe noise is prevented from being mixed into read image data.

The dusting timing by the duster 46 may be adjusted in accordance with the document feeding speed. Alternatively, the speed of the cleaner 45 for the cleaning operation may be set to a specified speed, regardless of the document feeding speed and the speed of the cleaner 45 for a return to the home position. Further, the number of slaps in the dusting operation and the speed of the slaps may be adjusted in accordance with the length of the period required for the document to pass through the reading position A. These will be described later.

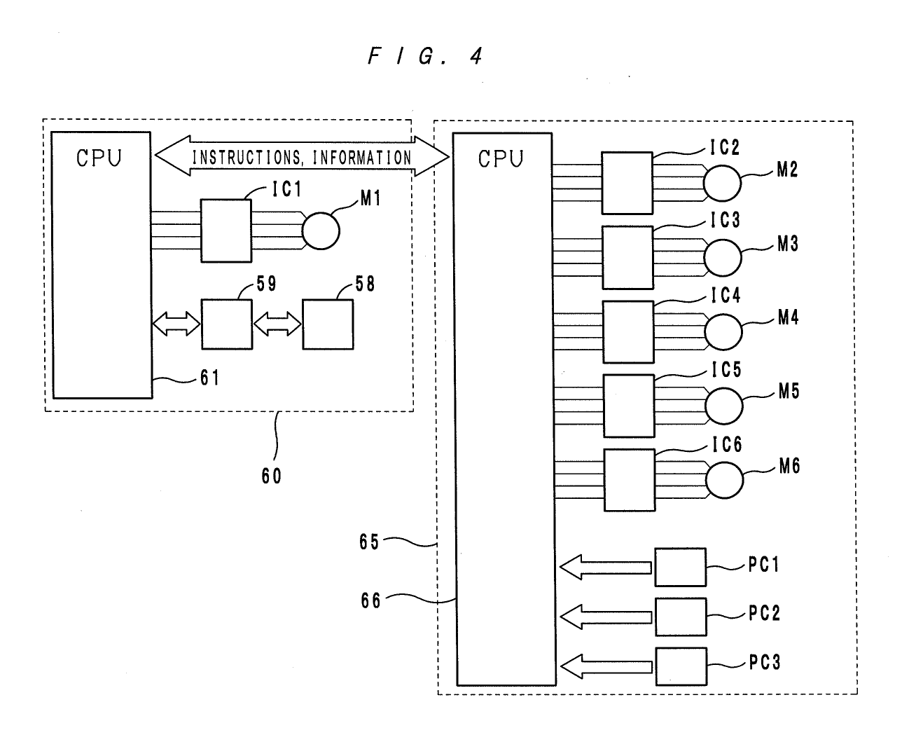

As shown by FIG. 4, the control section comprises a control unit 60 for the optical system 50 and a control unit 65 for the document feeder 20, and the control units 60 and 65 exchange instructions and information with each other. In the control unit 60 for the optical system 50, a CPU 61 is connected to a motor M1 for driving the sliders 51 and 52 via a motor driving circuit IC1, and the CPU 61 is also connected to the image pick-up section 58 via an image processor 59.

In the control unit 65 for the document feeder 20, the CPU 66 is connected to a motor M2 for driving the feed roller 22, a motor M3 for driving the resist rollers 23, a motor M4 for driving the reading rollers 24 and 25, a motor M5 for driving the ejection rollers 26 and 27, a motor M6 for driving the cleaner 45, respectively via motor driving circuits IC2-IC6. Further, detection signals are inputted to the CPU 66 from the pre-resist sensor PC1, the pre-reading sensor PC2 and the home position sensor PC3 for the cleaner 45.

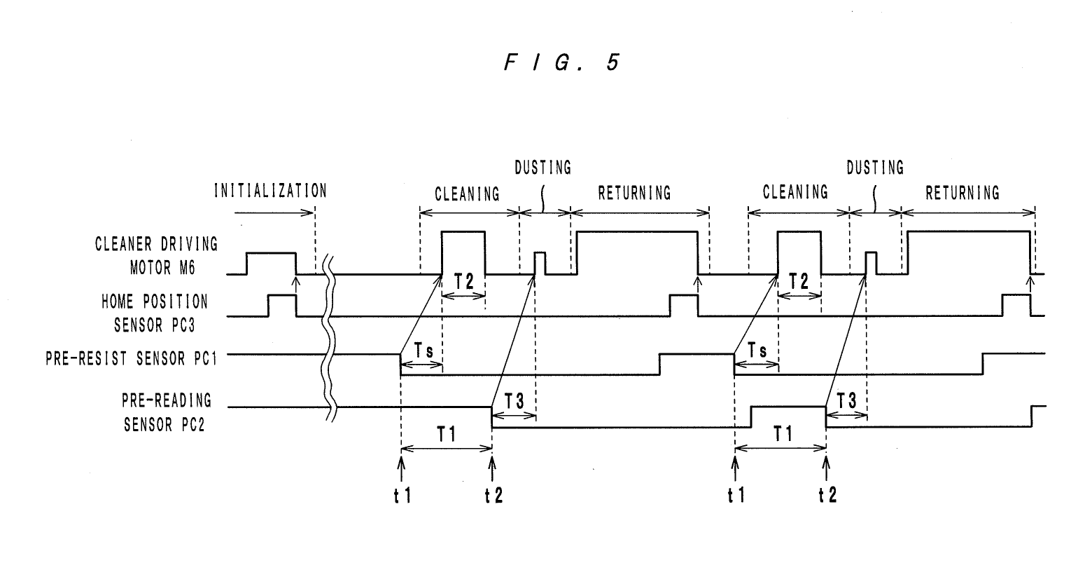

Now, referring to FIG. 5, a control sequence for image reading is described. First, as an initial motion, the motor M6 is rotated to return the cleaner 45 to the home position. When a plurality of documents are placed on the tray 21, the documents are picked up and fed out by the feed roller 22 one by one. At the start of feeding of each document, the document feeding speed is set to a value in accordance with the magnification and the kind of the document that were set beforehand. After the leading edge of a document is detected by the pre-resist sensor PC1 (after the time t1), the leading edge of the document is pressed against the resist rollers 23 for a specified time so that a possible skew of the document can be corrected. Thereafter, the resist rollers 23 are driven to rotate.

After the specified time elapsed, the resist rollers 23 are rotated, and thereby, the document is fed forward. Then, the leading edge of the document reaches the reading rollers 24 and is detected by the pre-reading sensor PC2 (at the time t2). The cleaner 45 starts rotating for a cleaning operation when a specified time length Ts has passed since the time t1 (see FIG. 2(A)) and finishes the rotation for the cleaning operation before the time t2 (see FIG. 2(B)). The cleaning operation has a time length of T2.

The time length T1, which is the time required for the leading edge of the document to travel from the pre-resist sensor PC1 to the pre-reading sensor PC2, is expressed by T1=L/S, wherein L is the travel distance from the pre-resist sensor PC1 to the pre-reading sensor PC2, and S is the document feeding speed. Because the cleaner 45 must be rotated at a speed appropriate for cleaning regardless of the document feeding speed S, the time length T2 for a cleaning operation of the cleaner 45 is fixed. A time length Ts, which is the lag between the time t1 and the start of rotation of the cleaner 45 for the cleaning operation, must be set to satisfy the condition Ts=T1−T2.

After the cleaner 45 cleans the reading glass 40, the leading edge of the document passes the pre-reading sensor PC2, and the document starts passing on the reading glass 40, whereby the optical system 50 starts reading the image of the document. Meanwhile, the cleaner 45 rotates forward and backward within the angle θ2 for the dusting operation as shown by FIG. 3(B), and thereby, dust collected in the brush 45b falls onto the reverse side of the document.

It is necessary that the dusting operation is carried out while the document is passing on the reading glass 40. A time, length T3, which is the lag between the time t2 and the start of the dusting operation, is preferably the time required for the leading edge of the document to travel from the pre-reading sensor PC2 to the reading rollers 25. In this embodiment, T3=L3/S is satisfied, wherein L3 is the travel distance from the pre-reading sensor PC2 to the reading rollers 25. The dusting operation may be one and a half or more reciprocating rotations of the cleaner 45 if there is enough time. Alternatively, the dusting operation may be a one-directional rotation, not a reciprocating motion, of the cleaner 45. Also, in accordance with the kind and the size of the documents, the number of slaps in the dusting operation may be changed, and the rotation of the cleaner 45 may be a one-directional motion, not a reciprocating motion.

After the dusting operation, the cleaner 45 returns to the home position before the next document is fed out. In this moment, the cleaner 45 is rotated in the direction “c” from the position for the dusting operation shown by FIG. 3(B), and thereby, the cleaner 45 returns to the home position without coming into contact with the traveling document.

According to this embodiment, when a document with images on both sides is subjected to image reading, the image reading apparatus is capable of reading the images on both sides of the document continuously. In this case, after reading of an image on a front side of the document, the document is temporarily fed into a sheet path 33, guided by the diverters 35 and 36. Thereafter, the document is fed into the cyclic sheet path 31 in a switchback manner, guided by the diverters 36 and 35, and thereby, the document is fed back to the resist rollers 23 again. The document is fed further, so that the image on the reverse side of the document is read. Additionally, a duster for removing dust from a document may be disposed in the document ejection section or in the cyclic sheet path 31.

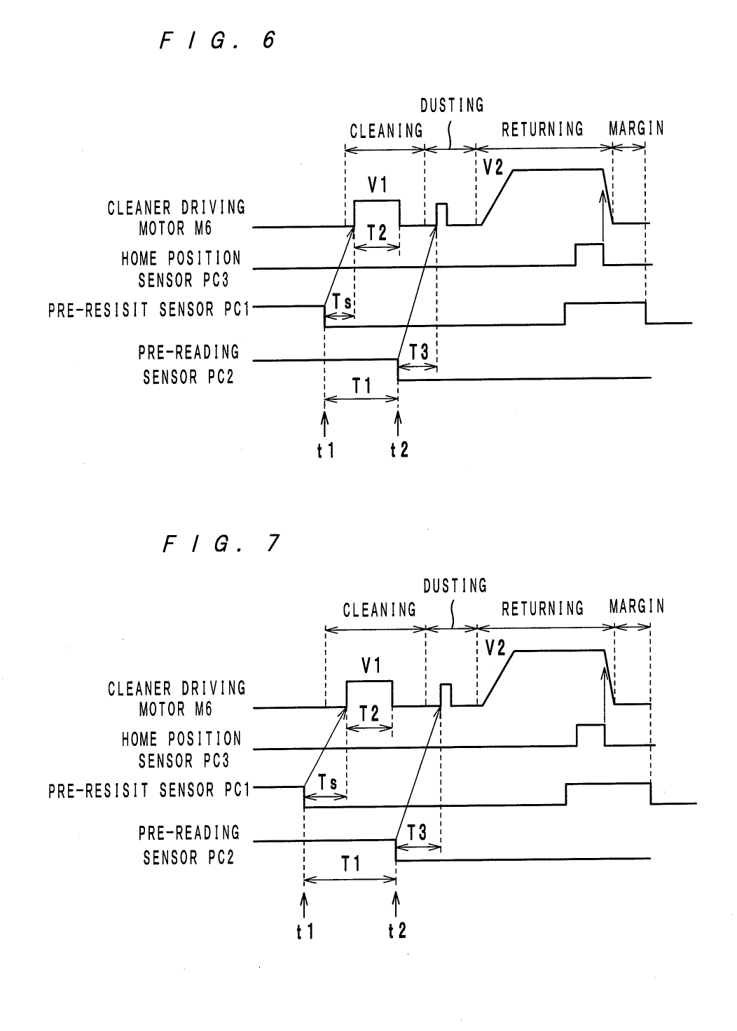

When the magnification of image reading is low, the document feeding speed S is high, and accordingly, the times Ts and T1 are short as shown by FIG. 6. In order to comply with this situation, the time length T3 from the detection of a document by the pre-reading sensor PC2 to the start of the dusting operation may be set shorter. On the other hand, when the magnification of image reading is high, that is, when the document feeding speed S is low, the time length T3 may be set longer as shown by FIG. 7, whereby the dusting operation does not start until the document covers the reading glass 40 certainly.

The rotation speed V1 of the cleaner 45 for the cleaning operation (and accordingly the time length T2 for a cleaning operation) is preferably fixed to a value appropriate for collecting dust with the brush 45b, regardless of the document feeding speed S. As shown by the timing charts of FIGS. 5, 6 and 7, the time length T2 for a cleaning operation is fixed. However, the time length for a cleaning operation and the number of slaps in the dusting operation may be changed in accordance with the length of the period for which a document is passing the reading position A, which mainly depends on the size of the document and the magnification of image reading.

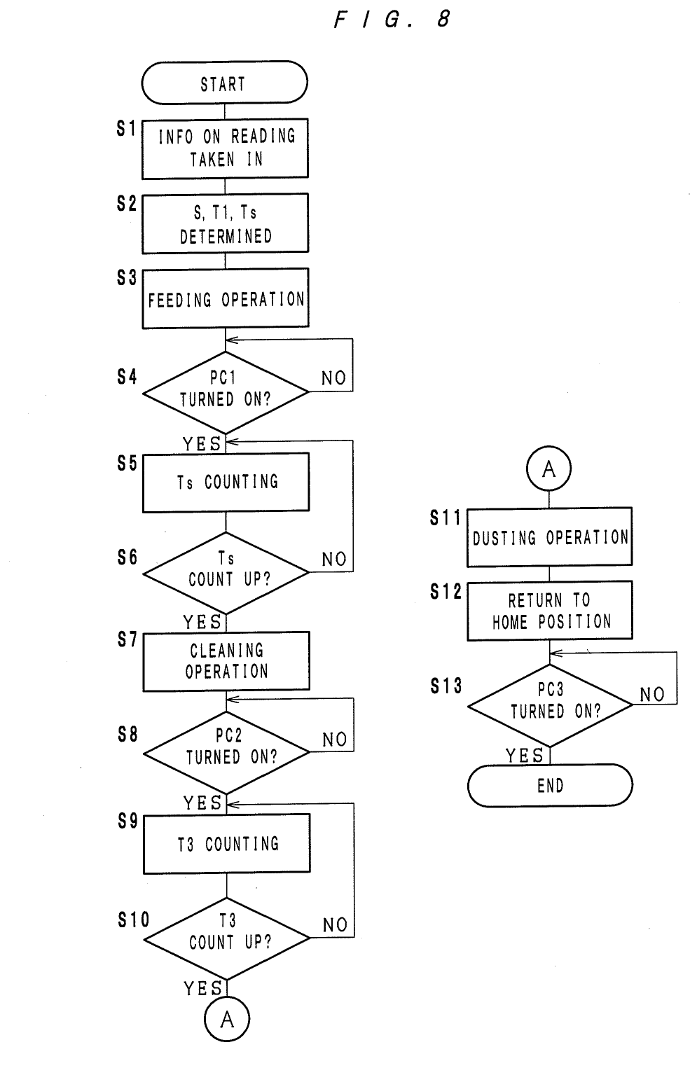

FIG. 8 shows a first exemplary control procedure. The CPU 66 takes information about the document size, the grade of image reading, the magnification of image reading and so on (step S1) and determines the document feeding speed S and the time lengths T1 and Ts (step S2). Thereafter, feeding of a document is started (step S3). When the leading edge of the document is detected by the pre-resist sensor PC1 (“YES” at step S4), a timer Ts is started (step S5). When the timer Ts counts up (“YES” at step S6), the cleaning operation is started (step S7).

Subsequently, when the leading edge of the document is detected by the pre-reading sensor PC2 (“YES” at step S8), a timer T3 is started (step S9). When the timer T3 counts up (“YES” at step S10), the dusting operation is started (step S11). Thereafter, the cleaner 45 is rotated to return to the home position (step S12). When the home position sensor PC3 is turned on (“YES” at step S13), this procedure is completed. This control procedure is a procedure during feeding of one document for image reading. When multiple documents are subjected to image reading, this procedure is carried out in parallel for every document.

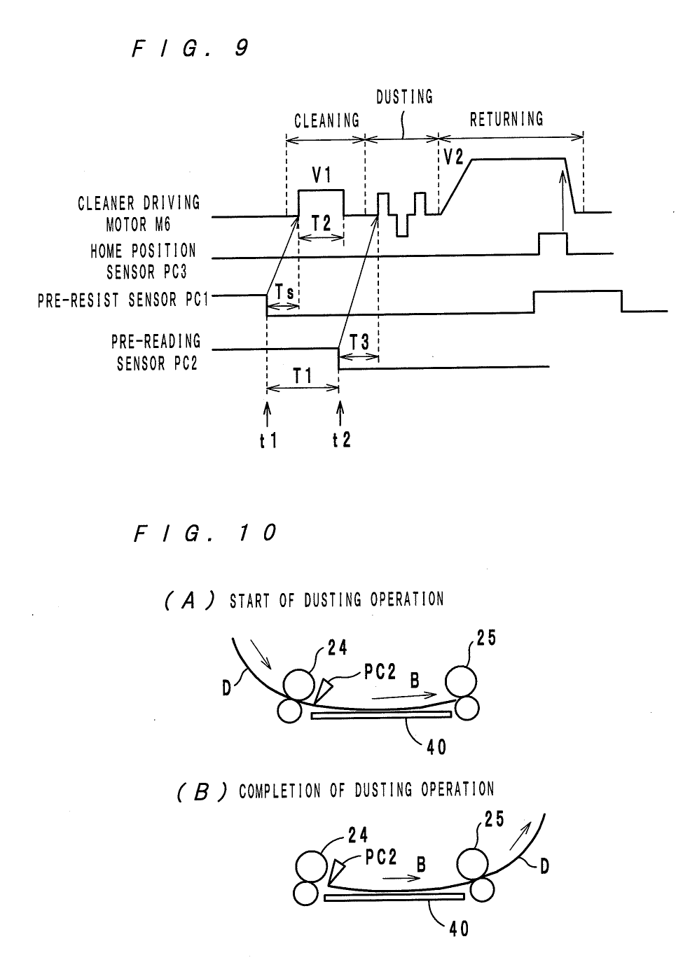

As mentioned above, the dusting operation may include two or more slaps. When the document size is larger than a specified size or when the document feeding speed S is lower than a specified speed, there is enough time for two or more slaps (three slaps in the case of FIG. 9).

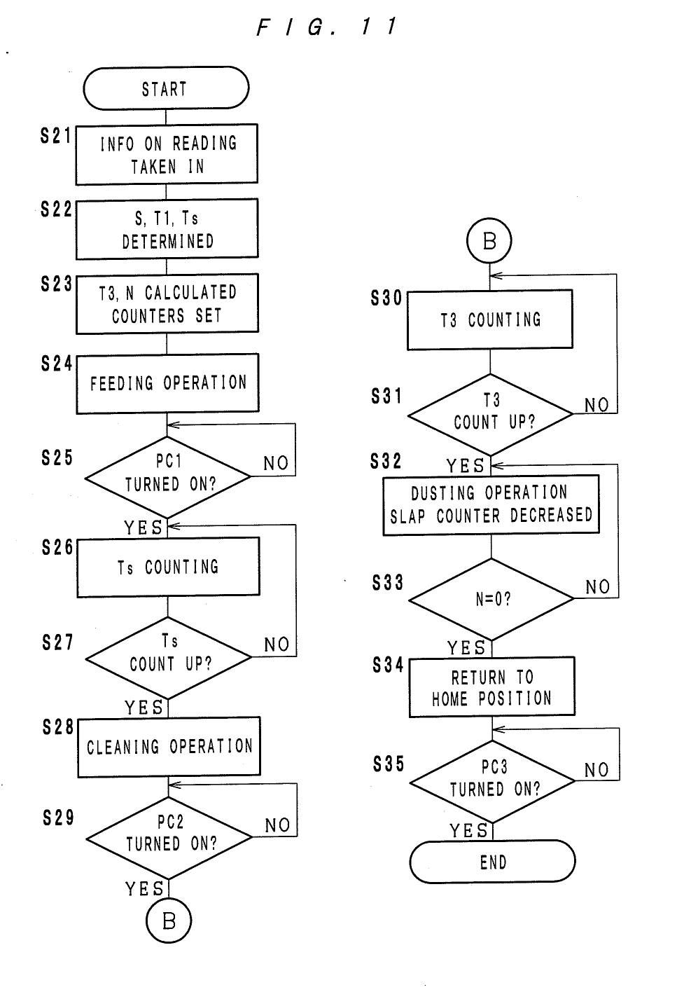

The dusting operation must be carried out and completed during the period from the arrival of the leading edge of the document D at the reading rollers 25 (see FIG. 10(A)) to the departure of the trailing edge of the document D from the pre-reading sensor PC2 (see FIG. 10(B)), that is, while the document D is covering the reading glass 40. Accordingly, the possible time length for the dusting operation Th is expressed by Th=(Lp/S)−T3, wherein Lp is the length of the document, and S is the document feeding speed. The possible number of slaps N in the dusting operation is expressed by N=(Th−Tf)/Tn, wherein Tn is the time required for one slap, and Tf is a time required for the cleaner 45 to return to the home position.

FIG. 11 is a second exemplary control procedure, wherein the dusting operation includes multiple slaps. The CPU 66 takes information about the document size, the grade of image reading, the magnification of image reading and so on (step S1) and determines the document feeding speed S and the time lengths T1 and Ts (step S2). Further, the CPU calculates the time length T3 and the number of slaps N, and sets the value N in a counter (step S23). Thereafter, feeding of a document is started (step S24). When the leading edge of the document is detected by the pre-resist sensor PC1 (“YES” at step S25), the timer Ts is started (step S26). When the timer Ts counts up (“YES” at step S27), the cleaning operation is started (step S28).

Subsequently, when the leading edge of the document is detected by the pre-reading sensor PC2 (“YES” at step S29), the timer T3 is started (step S30). When the timer T3 counts up (“YES” at step S31), the dusting operation is started, and simultaneously, the counter value of the slap counter is decreased by one (step S32). The cleaner 45 is rotated to slap against the duster 46 repeatedly until the counter value becomes zero. When the counter value becomes zero (“YES” at step S33), the cleaner 45 is rotated to return to the home position (step S34). When the home position sensor PC3 is turned on (“YES” at step S35), this procedure is completed. This control procedure is a procedure during feeding of one document for image reading. When multiple documents are subjected to image reading, this procedure is carried out in parallel for every document.

In this embodiment, documents are fed above the reading glass 40 without coming into contact with the reading glass 40. This is to avoid trouble that sticky matters on the documents will be transferred onto the reading glass 40. Such non-contact feeding can be achieved by disposing a guide sheet at an upstream position from the reading glass 40 with respect to the document feeding direction B to make a step or by controlling the reading rollers 24 and 25 to curve and feed the document. Such mechanisms for non-contact feeding are well known. Alternatively, when documents are fed, each document may come into contact with the reading glass 40.

Image reading apparatuses according to the present invention are not limited to the embodiments above. Various changes and modifications are possible within the scope of the invention.

For example, in the embodiment above, the cleaner is rotated to slap against the duster, while the duster is fixed at a position. However, the duster may be rotated, while the cleaner is fixed.

As described above, the present invention is effective to an image reading apparatus, and the present invention is advantageous especially in that dust collected from a transparent member by a cleaner can be ejected to the outside in a simple structure and that stripe noise is prevented from being mixed into read image data.

### DESCRIPTION OF THE REFERENCE SYMBOLS

10: image reading apparatus
20: automatic document feeder
40: reading glass
45: cleaner
45b: brush
46: duster
50: reading optical system
66: CPU
A: reading position
B: document feeding direction

1. An image reading apparatus comprising:
an automatic document feeder for feeding documents one by one such that each document can pass through a reading position;
an image reader for optically reading an image of a document while the image is passing the reading position;
a transparent member that is disposed between the document passing the reading position and the image reader;
a brush type cleaner that is disposed to face to the transparent member at the reading position and that is capable of rotating to perform a cleaning operation to clean the transparent member;
a duster that is disposed at a downstream position from the cleaner with respect to a document feeding direction and that is capable of slapping against the cleaner to perform a dusting operation to remove dust from the cleaner; and
a controller that controls rotation of the cleaner,
wherein the controller controls the cleaning operation to be carried out before a leading edge of a document comes to the reading position and controls the dusting operation to be carried out while the document is covering the transparent member.

2. An image rading apparatus according to claim 1, wherein the dusting operation is rotating the cleaner reciprocally within a specified angle such that the cleaner slaps against the duster that is fixedly provided.

3. An image reading apparatus according to claim 1, wherein the controller controls the dusting operation to be started at a time in accordance with a document feeding speed.

4. An image reading apparatus according to claim 1, wherein the controller sets a speed of the cleaner for the cleaning operation to a specified value, regardless of the document feeding speed and a rotation speed of the cleaner for a return to a home position.

5. An image reading apparatus according to claim 1, wherein the controller sets a number of slaps in the dusting operation and speeds of the slaps in accordance with a time required for the document to pas through the reading position.
